(19) United States
(12) Patent Application Publication
(10) Pub. No.: US 2006/0287780 A1
(43) Pub. Date: Dec. 21, 2006

(54) Automated passenger boarding bridge alignment system and method with aircraft-based emergency stop control

(75) Inventor: Neil Hutton, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: DEW Engineering and Development Limited, Ottawa (CA)

(21) Appl. No.: 11/155,502

(22) Filed: Jun. 20, 2005

(51) Int. Cl. G01C 23/00

(52) U.S. Cl. 701/3

(57) ABSTRACT

A system for aligning an aircraft-engaging end of a passenger boarding bridge to a doorway along a lateral surface of an aircraft includes a bridge controller for performing automated alignment of the aircraft-engaging end of the passenger boarding bridge to the doorway. A user interface is located aboard the aircraft for receiving, from a user aboard the aircraft, an input signal relating to a command for aborting automated alignment of the aircraft-engaging end of the passenger boarding bridge, and for providing data relating to the input signal. A transmitter is also located aboard the aircraft and in communication with the user interface, the transmitter for receiving the data relating to the input signal and for transmitting a first signal including the data relating to the input signal. Furthermore, a receiver is located at a location that is remote from the aircraft and is in communication with the bridge controller, for receiving the first signal and for providing to the bridge controller an electrical output signal relating to the first signal. During use, the bridge controller aborts an automated alignment process already in progress in dependence upon receiving the electrical output signal.

### FIELD OF THE INVENTION

The instant invention relates generally to a system and method for aligning a passenger boarding bridge to a doorway that is disposed along a lateral surface of an aircraft, and more particularly to an automated passenger boarding bridge system and method with aircraft-based emergency stop control.

### BACKGROUND

In order to make aircraft passengers comfortable, and in order to transport them between an airport terminal building and an aircraft in such a way that they are protected from weather and other environmental influences, passenger boarding bridges are used which can be telescopically extended and the height of which is adjustable. For instance, an apron drive bridge in present day use includes a plurality of adjustable modules, including: a rotunda, a telescopic tunnel, a bubble section, a cab, and elevating columns with wheel carriage. Manual, semi-automated and fully-automated bridge alignment systems are known for adjusting the position of the passenger boarding bridge relative to an aircraft, for instance to compensate for different sized aircraft and to compensate for imprecise parking of an aircraft at an airport terminal.

Automated bridge alignment systems provide a number of advantages compared to manual and semi-automated systems. For instance, automated bridge alignment systems do not require a human operator, and therefore the costs that are associated with training and paying the salaries of human bridge operators are reduced. Furthermore, an automated bridge alignment system is always standing by to control the passenger boarding bridge as soon as an aircraft comes to a stop. Accordingly, delays associated with dispatching a human operator to perform a bridge alignment operation are eliminated, particularly during periods of heavy aircraft travel.

Of course, manual and semi-automated systems require a human operator to control certain aspects of the alignment process. During the alignment process, the human operator observes the movement of the passenger boarding bridge relative to the aircraft and judges whether or not it is safe to continue the alignment process. If the human operator perceives that a danger is developing, such as for instance a close approach between a portion of the passenger boarding bridge and the aircraft, then the human operator can stop movement of the passenger boarding bridge toward the aircraft. Unfortunately, most automated bridge alignment systems lack any such predictive capabilities and therefore there is a risk that the passenger boarding bridge may be driven into contact with the aircraft, resulting in damage that is sufficient to render the aircraft unfit to continue service. Delays resulting from damage to an aircraft are costly to the airlines and cause significant inconvenience to passengers.

It would be advantageous to provide a system and method that overcomes at least some of the above-mentioned limitations of the prior art.

### SUMMARY OF EMBODIMENTS OF THE INVENTION

In accordance with an aspect of the instant invention there is provided a system for aligning an aircraft-engaging end of a passenger boarding bridge to a doorway disposed along a lateral surface of an aircraft, comprising: a bridge controller for performing automated alignment of the aircraft-engaging end of the passenger boarding bridge to the doorway; a user interface disposed aboard the aircraft for receiving from a user aboard the aircraft an input signal relating to a command for aborting automated alignment of the aircraft-engaging end of the passenger boarding bridge to the doorway, and for providing data relating to the input signal; a first transmitter disposed aboard the aircraft and in communication with the user interface, the first transmitter for receiving the data relating to the input signal and for transmitting a first signal including the data relating to the input signal; and, a first receiver disposed at a location that is remote from the aircraft and in communication with the bridge controller, for receiving the first signal and for providing to the bridge controller an electrical output signal relating to the first signal, wherein, during use, the bridge controller aborts an automated alignment process already in progress in dependence upon receiving the electrical output signal.

In accordance with another aspect of the instant invention there is provided a method of aligning an aircraft-engaging end of a passenger boarding bridge to a doorway disposed along a lateral surface of an aircraft, comprising: initiating an automated alignment process for aligning the aircraft-engaging end of the passenger boarding bridge to the doorway disposed along the lateral surface of the aircraft; receiving from a user aboard the aircraft an input signal relating to a command for aborting the automated alignment process; wirelessly transmitting a first signal including data relating to the input signal; receiving the first signal at a location that is remote from the aircraft and providing an output signal in dependence thereon; providing the output signal to a controller of an automated alignment system of the passenger boarding bridge; and, aborting the automated-alignment process based upon the output signal.

In accordance with another aspect of the instant invention there is provided a system for aligning an aircraft-engaging end of a passenger boarding bridge to a doorway disposed along a lateral surface of an aircraft, comprising: a receiver for receiving a wireless communication signal and for providing a control signal in dependence thereon; and, a controller for automatically aligning the passenger boarding bridge to an aircraft, the controller for receiving the control signal and for aborting an alignment operation of the passenger boarding bridge in response thereto.

### BRIEF DESCRIPTION OF THE DRAWINGS

Exemplary embodiments of the invention will now be described in conjunction with the following drawings, in which similar reference numbers designate similar items:

FIG. 1a is a simplified flow diagram of a method of aligning an aircraft-engaging end of a passenger boarding bridge to a doorway disposed along a lateral surface of an aircraft, according to an embodiment of the instant invention;

FIG. 1b is a simplified flow diagram of another method of aligning an aircraft-engaging end of a passenger boarding bridge to a doorway disposed along a lateral surface of an aircraft, according to an embodiment of the instant invention;

FIG. 2 is a simplified block diagram of a system according to an embodiment of the instant invention; and,

FIG. 3 is a simplified block diagram of another system according to an embodiment of the instant invention.

### DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

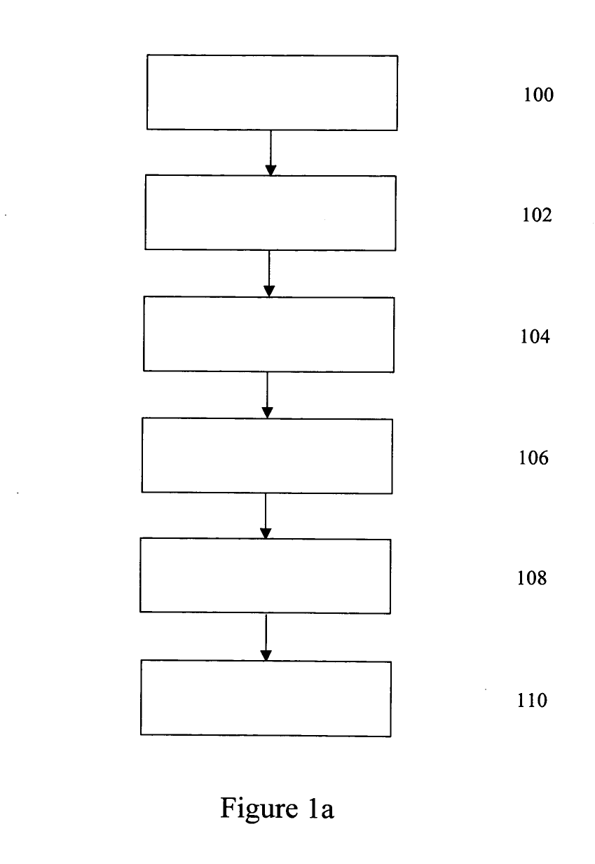

Referring to FIG. 1a, shown is a simplified flow diagram of a method of aligning an aircraft-engaging end of a passenger boarding bridge to a doorway disposed along a lateral surface of an aircraft, according to an embodiment of the instant invention. At step 100 an automated alignment process is initiated for aligning the aircraft-engaging end of the passenger boarding bridge to the doorway of the aircraft. At step 102 an input signal relating to a command for aborting the automated alignment process is received from a user aboard the aircraft. The user provides the input signal only if, in the opinion of the user, it is necessary to abort the automated alignment process prior to completion of the process. Some non-limiting examples of conditions under which it may be necessary to abort the automated alignment process include a collision between the passenger boarding bridge and either the aircraft or a piece of ground service equipment being imminent, uncontrolled skidding of the bridge drive wheels, the bridge apparently attempting to align with the wrong doorway of the aircraft, etc. At step 104, a transmitter that is disposed aboard the aircraft wirelessly transmits a first signal including data relating to the input signal. For instance, the first signal is an electromagnetic signal, optionally an optical signal or a radio frequency signal. At step 106, a receiver that is disposed at a location that is remote from the aircraft receives the first signal and provides an electrical output signal in dependence thereon. At step 108 the electrical output signal is provided to a controller of an automated alignment system of the passenger boarding bridge. At step 110 the controller aborts the automated alignment process based upon the electrical output signal. Optionally, the user aboard the aircraft monitors the automated alignment process by directly observing the aircraft-engaging end of the passenger boarding bridge through one of the aircraft windows or through an open door of the aircraft. Further optionally, the user aboard the aircraft monitors the automated alignment process by viewing displayed images of the aircraft-engaging end of the passenger boarding bridge.

Referring to FIG. 1b, shown is a simplified flow diagram of a method of aligning an aircraft-engaging end of a passenger boarding bridge to a doorway that is disposed along a lateral surface of an aircraft, according to an embodiment of the instant invention. At step 112 an automated alignment process is initiated for aligning the aircraft-engaging end of the passenger boarding bridge to the doorway of the aircraft. At step 114 an image of the lateral surface of the aircraft is captured and displayed to a user aboard the aircraft via a display device that is disposed aboard the aircraft. At decision step 116 the user determines whether the automated alignment process should be aborted. If the answer is no, then the user takes no action and the automated alignment process continues at step 118. Steps 114 through 118 are repeated until the automated alignment process is complete, or until at step 116 the answer is yes. When the answer at step 116 is yes, the user provides at step 120 an input signal that is indicative of an abort command. At step 122 a transmitter aboard the aircraft is used to transmit a signal including data indicative of the input signal, to a receiver at the location that is remote from the aircraft. For instance, the signal is an electromagnetic signal, optionally an optical signal or a radio frequency signal. At step 124, the receiver provides an electrical output signal, including the data indicative of the input signal, to a controller of an automated bridge alignment system. At step 126, the controller of the automated bridge alignment system aborts the automated alignment process prior to its completion, based upon the electrical output signal.

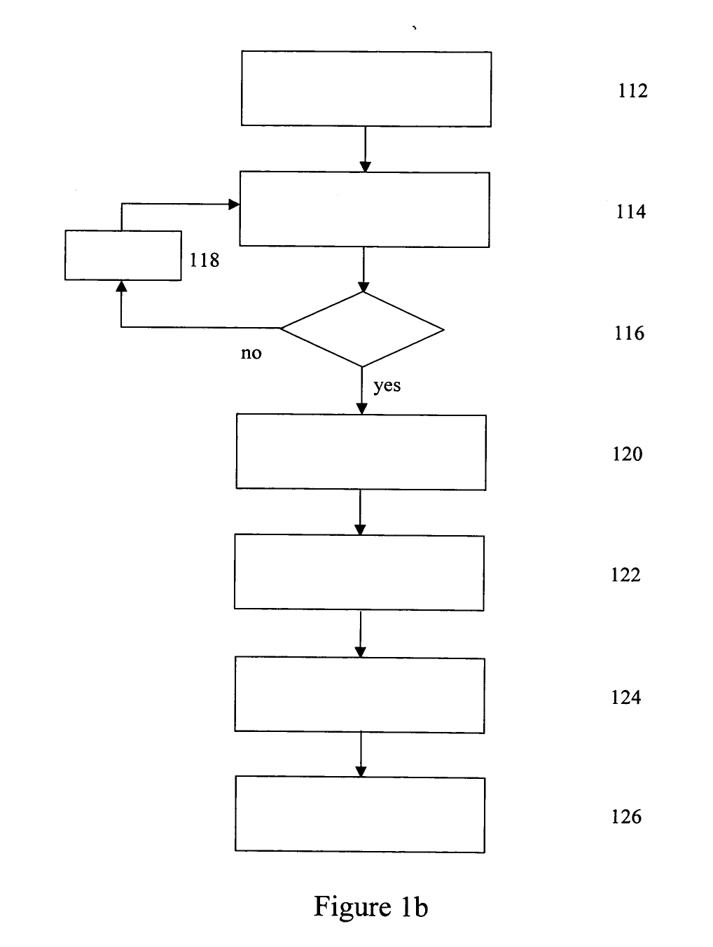

Referring now to FIG. 2, shown is a simplified block diagram of a system according to an embodiment of the instant invention. The system includes components shown generally at 200, which are disposed at a location that is remote from the aircraft, and components shown generally at 202, which are disposed aboard the aircraft. By way of one non-limiting example, which is provided for illustrative purposes only and is not intended to in any way limit the scope of the invention, the components 200 are disposed near an aircraft-engaging end of a passenger boarding bridge, and the components 202 are disposed in the cockpit area of an aircraft. The components 202 include a user interface 204 and a transmitter 206. The components 200 include a receiver 208, and a processor 210 such as for instance a processor of an automated bridge controller 212.

Referring still to FIG. 2, during use a user aboard the aircraft observes a position of the aircraft-engaging end of the passenger boarding bridge, for instance by looking through one of the cockpit windows or by looking out through another window or an open doorway of the aircraft. The user aboard the aircraft, such as for instance the aircraft pilot, continues to monitor the aircraft-engaging end of the passenger boarding bridge as it is aligned with the aircraft doorway in an automated manner. Provided the automated alignment process proceeds in a manner that the user considers to be safe, no action is taken by the user and the alignment operation continues to its completion. However, in the event that the user perceives a danger or a potential danger, then the user provides an abort command via the user interface 204 for transmission to the processor 210 of the automated bridge controller 212 via transmitter 206 and receiver 208. For instance, the user provides the abort command when, in the opinion of the user, a collision between the passenger boarding bridge and either the aircraft or a piece of ground service equipment appears to be imminent. The user may also choose to abort the automated alignment process if, for example, the bridge drive wheels appear to be skidding or the bridge appears to be attempting to align with the wrong doorway of the aircraft. Once the processor receives the abort command, the automated alignment process is stopped. Optionally, the bridge is simply halted at its current position or is returned to a predetermined position away from the aircraft.

Preferably, the user interface 204 is configured for providing only one type of command, namely a command for aborting a current automated alignment process subsequent to initiation of the automated alignment process. Via the user interface 204, the user provides an input signal for transmitting the abort command, for instance, by depressing a button, by toggling or throwing a switch, by providing a biometric input signal to a biometric information reader or by providing a security token to a token reader. Once the user has provided the input signal, the user interface provides an output signal to the transmitter 206. The transmitter 206 transmits a signal to the receiver 208, which receives the signal and provides an electrical output signal to the processor 210. Any suitable combinations of transmitter 206 and receiver 208 may be used, such as for instance a radio-frequency receiver/transmitter pair or an optical receiver/transmitter. When a plurality of passenger boarding bridges, and therefore a plurality of transmitters, is installed at an airport terminal, optionally each radio-frequency transmitter transmits using a different frequency or a different channel in order to reduce interference and cross-talk. Alternatively, different identification coding is used to ensure that communication is between the transmitter and the receiver. One of skill in the art of wireless communication will readily comprehend how to ensure that a receiver and transmitter communicate absent confusion between receivers and transmitters. In the case of optical transmitters, any suitable wavelength that is selected from the infrared, visible and ultra-violet regions of the electromagnetic spectrum may be used. Since optical transmitters are highly directional, and accordingly the chances of interference or cross-talk is low, optionally each transmitter uses a different wavelength or a same wavelength.

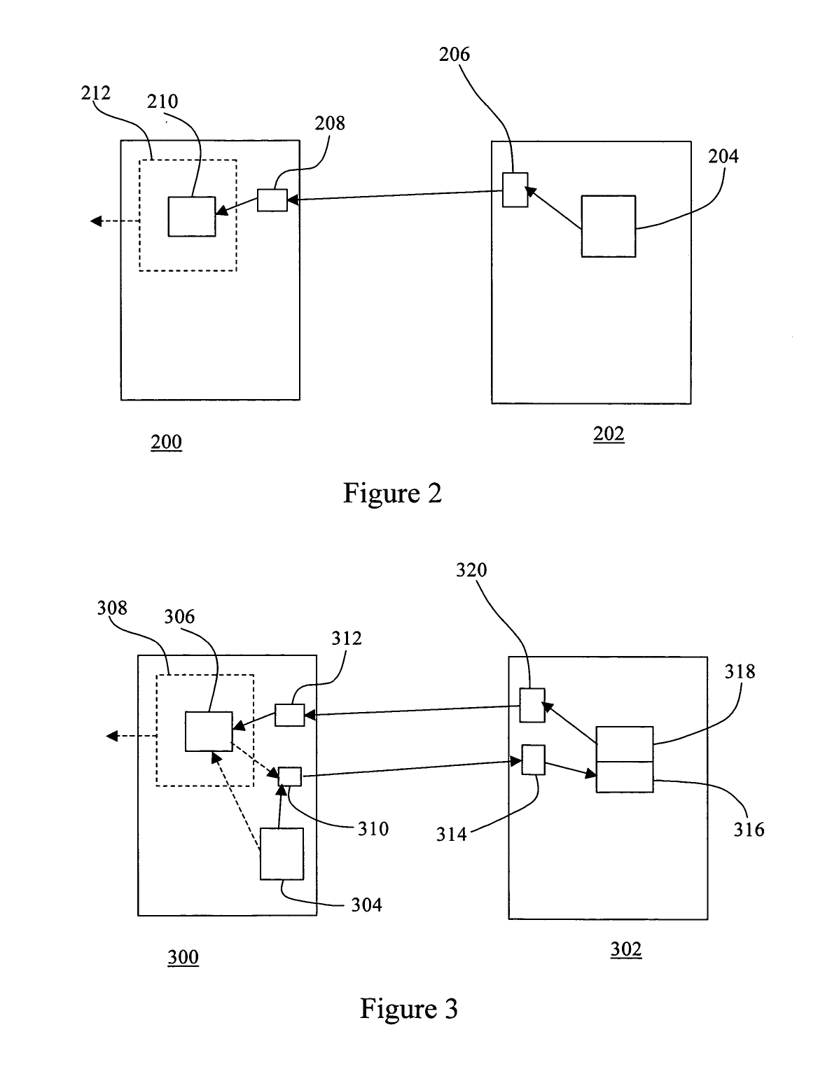

Referring now to FIG. 3, shown is a simplified block diagram of a system according to an embodiment of the instant invention. The system includes components shown generally at 300, which are disposed at a location that is remote from the aircraft, and components shown generally at 302, which are disposed aboard the aircraft. By way of one non-limiting example, which is provided for illustrative purposes only and is not intended to in any way limit the scope of the invention, the components 300 are disposed near an aircraft-engaging end of a passenger boarding bridge, and the components 302 are disposed in the cockpit area of an aircraft. The components 300 include an imager 304, a processor 306 such as for instance a processor of an automated bridge controller 308, a transmitter 310 and a receiver 312. The components 302 include a receiver 314, a display device 316, a user interface 318 and a transmitter 320. Optionally, the components 300 also include at least a light (not shown) for illuminating the lateral surface of the aircraft including the doorway when operating under poor lighting conditions. For instance, a light source such as for instance a bank of lights is provided for illuminating the lateral surface of the aircraft including the doorway during nighttime operation. Further optionally, a plurality of light sources, such as for instance a plurality of light banks, is provided to support operation of the system under a variety of poor lighting conditions. For instance, two or more banks of lights are used simultaneously to illuminate the lateral surface of the aircraft including the doorway when operating in rainy or snowy conditions.

Referring still to FIG. 3, the imager 304 is disposed for capturing an image of a lateral surface of an aircraft including a doorway to which the aircraft-engaging end of the passenger boarding bridge is to be aligned. Optionally, the imager is disposed at the aircraft-engaging end of the passenger boarding bridge, or at some other location such as for instance along a terminal building wall near the passenger boarding bridge. The imager 304 is provided in the form of, for instance, a digital still camera, a digital video camera, a range sensor, etc. Of course, any other imager that is suitable for capturing an image of the lateral surface of an aircraft may be used. During use, the imager 304 provides image data to the transmitter 310, which wirelessly transmits a signal including the image data to the receiver 314 aboard the aircraft. Optionally, the imager 304 also provides image data to the processor 306. An electrical output signal is provided from the receiver 314 to the display device 316. The display device displays the image data in a human intelligible form to the user aboard the aircraft. The user aboard the aircraft, such as for instance the aircraft pilot, views the displayed image data to monitor the aircraft-engaging end of the passenger boarding bridge as it is aligned in an automated manner with the aircraft doorway. Provided the automated alignment process proceeds in a manner that the user considers to be safe, no action is taken by the user and the automated alignment process continues to its completion. However, in the event that the user perceives a danger or a potential danger, then the user provides an abort command via the user interface 318 for transmission to the processor 306 of the automated bridge controller 308 via transmitter 320 and receiver 312. For instance, the user provides the abort command when, in the opinion of the user, a collision between the passenger boarding bridge and either the aircraft or a piece of ground service equipment appears to be imminent. The user may also choose to abort the automated alignment process if, for example, the bridge drive wheels appear to be skidding or the bridge appears to be attempting to align with the wrong doorway of the aircraft. Once the processor 306 receives the abort command, the automated alignment process is stopped. Optionally, the bridge is simply halted at its current position or is returned to a predetermined position away from the aircraft.

Preferably, the user interface 318 is configured for providing only one type of command, namely a command for aborting a current automated alignment process subsequent to initiation of the automated alignment process. Via the user interface 318, the user provides an input signal for transmitting the abort command, for instance, by depressing a button, by toggling or throwing a switch, by providing a biometric input signal to a biometric information reader or by providing a security token to a token reader. Optionally, the buttons or switches of the user interface 318 are mechanical or electronic or virtual in nature. Of course, virtual buttons or switches require a touch sensitive display screen, a pointing device such as a mouse, a trackball, a track pad, another pointing device, or some other similar technology in order to receive an input signal from the user.

Once the user has provided the input signal, the user interface 318 provides an electrical output signal to the transmitter 320. The transmitter 320 transmits a signal to the receiver 312, which receives the signal and provides an electrical output signal to the processor 306. Any suitable combinations of transmitter 320 and receiver 312 may be used, such as for instance a radio-frequency receiver/transmitter pair or an optical receiver/transmitter. When a plurality of passenger boarding bridges, and therefore a plurality of transmitters, is installed at an airport terminal, optionally each radio-frequency transmitter transmits using a different frequency or channel in order to reduce interference and cross-talk. Alternatively different coding is used for communicating between different transmitter receiver pairs to reduce a potential of confusion between transmitters and receivers. In the case of optical transmitters, any suitable wavelength that is selected from the infrared, visible and ultra-violet regions of the electromagnetic spectrum may be used. Since optical transmitters are highly directional, and accordingly the chances of interference or cross-talk is low, optionally each transmitter uses a different wavelength or a same wavelength.

Though the above embodiments are described with reference to particular methods of communication for reducing confusion and/or cross talk, one of skill in the art will readily be aware of many techniques for ensuring that a receiver only receives a signal from a particular transmitter or that the receiver can distinguish the signal received from that transmitter from other signals received. Some non-limiting examples include providing a code on each aircraft indicating its communication method, providing a code on each bridge indicating its communication method, receiving encoding information from a central database relating to an encoding for use in communication from the transmitter to the receiver, providing a visual indicator that is visible to a sensor on the passenger boarding bridge such as a red light, a flashing light or a pattern for being imaged by the sensor. Providing transmitters with very limited range within the aircraft to allow communication with the passenger boarding bridge only when it is very close to the aircraft will also reduce confusion between transmitter and receiver pairs.

It is an advantage of at least some embodiments of the instant invention that alignment of a passenger boarding bridge to a doorway of an aircraft is performed in a mostly automated manner, but with the additional security and safety of having a human “observer” that is able to abort the automated alignment process under unusual or dangerous operating conditions. The human “observer” does not actively control the movement of the bridge toward the doorway of the aircraft, and accordingly the possibility of an accident occurring as a result of human error is minimized. However, the predictive capabilities of the human observer may still be exploited in order to avoid system mistakes during an automated alignment process, since the human “observer” is provided with an interface for aborting the automated alignment process at their discretion.

Numerous other embodiments may be envisaged without departing from the spirit and scope of the invention.

What is claimed is:

1. A system for aligning an aircraft-engaging end of a passenger boarding bridge to a doorway disposed along a lateral surface of an aircraft, comprising:
a bridge controller for performing automated alignment of the aircraft-engaging end of the passenger boarding bridge to the doorway;
a user interface disposed aboard the aircraft for receiving from a user aboard the aircraft an input signal relating to a command for aborting automated alignment of the aircraft-engaging end of the passenger boarding bridge to the doorway, and for providing data relating to the input signal;
a first transmitter disposed aboard the aircraft and in communication with the user interface, the first transmitter for receiving the data relating to the input signal and for transmitting a first signal including the data relating to the input signal; and,
a first receiver disposed at a location that is remote from the aircraft and in communication with the bridge controller, for receiving the first signal and for providing to the bridge controller an electrical output signal relating to the first signal, wherein, during use, the bridge controller aborts an automated alignment process already in progress in dependence upon receiving the electrical output signal.

2. A system according to claim 1, comprising an imager disposed at a location that is remote from the aircraft, the imager for capturing an image of the lateral surface of the aircraft.

3. A system according to claim 2, comprising a second transmitter in communication with the imager for receiving image data relating to the captured image and for transmitting a second signal including the image data.

4. A system according to claim 3, comprising a second receiver disposed aboard the aircraft for receiving the second signal including the image data.

5. A system according to claim 4, comprising a display device disposed aboard the aircraft and in communication with the second receiver, the display device for receiving the image data from the first receiver and for displaying the image data in a human intelligible form to the user aboard the aircraft.

6. A system according to claim 5, comprising a processor for processing the image data prior to display by the display device.

7. A system according to claim 5, wherein the display device comprises a touch sensitive screen and wherein the user interface comprises at least one of a virtual button and an iconic symbol displayed by the touch sensitive screen.

8. A system according to claim 2, comprising at least a light source for illuminating a portion of the lateral surface of the aircraft that is being imaged by the imager.

9. A system according to claim 1, wherein the user interface comprises an actuator for generating an electrical signal indicative of a command for aborting a current automated alignment process.

10. A system according to claim 1, wherein the user interface comprises an emergency stop button.

11. A system according to claim 1, wherein the user interface comprises at least one of a biometric information reader and a security token reader.

12. A method of aligning an aircraft-engaging end of a passenger boarding bridge to a doorway disposed along a lateral surface of an aircraft, comprising:
initiating an automated alignment process for aligning the aircraft-engaging end of the passenger boarding bridge to the doorway disposed along the lateral surface of the aircraft;
receiving from a user aboard the aircraft an input signal relating to a command for aborting the automated alignment process;
wirelessly transmitting a first signal including data relating to the input signal;
receiving the first signal at a location that is remote from the aircraft and providing an output signal in dependence thereon;
providing the output signal to a controller of an automated alignment system of the passenger boarding bridge; and,
aborting the automated alignment process based upon the output signal.

13. A method according to claim 12, comprising capturing an image of a first portion of the lateral surface using an imager disposed at a location that is remote from the aircraft, wherein the image is captured prior to receiving the input signal from the user.

14. A method according to claim 13, wherein the imager is disposed near an aircraft-engaging end of the passenger boarding bridge, and comprising wirelessly transmitting a second signal including image data relating to the captured image, from a transmitter disposed at a location that is remote from the aircraft to a receiver that is disposed aboard the aircraft.

15. A method according to claim 14, comprising displaying in a human intelligible form using a display device disposed aboard the aircraft, the image data relating to the captured image.

16. A method according to claim 12, wherein the user aboard the aircraft observes a position of the aircraft-engaging end of the passenger boarding bridge from the aircraft and absent the use of an imager.

17. A method according to claim 12, wherein the input signal is provided for remotely aborting the automated alignment process in real time.

18. A method according to claim 12, wherein the wirelessly transmitted first signal includes a unique identifier for supporting secure communication between the controller and the aircraft during a current automated alignment process.

19. A method according to claim 12, wherein aborting the automated alignment process comprises stopping the aircraft-engaging end of the passenger boarding bridge at a current position.

20. A method according to claim 12, wherein aborting the automated alignment process comprises automatically driving the passenger boarding bridge to a predetermined position.

21. A method according to claim 20, wherein the predetermined position is a position for stowing the passenger boarding bridge between alignment processes.

22. A method according to claim 12, wherein aborting the automated alignment process comprises automatically paging a bridge operator for performing a manual alignment of the aircraft-engaging end of the passenger boarding bridge to the doorway of the aircraft.

23. A system for aligning an aircraft-engaging end of a passenger boarding bridge to a doorway disposed along a lateral surface of an aircraft, comprising:
a receiver for receiving a wireless communication signal and for providing a control signal in dependence thereon; and,
a controller for automatically aligning the passenger boarding bridge to an aircraft, the controller for receiving the control signal and for aborting an alignment operation of the passenger boarding bridge in response thereto.
